(19) United States
(12) Patent Application Publication
(10) Pub. No.: US 2001/0023207 A1
(43) Pub. Date: Sep. 20, 2001

(54) Elastic coupling for a control element

(75) Inventor: Marcus Zusch, Karben (DE)

Correspondence Address: Klaus P. Stoffel, Esq., Cohen, Pontani, Lieberman & Pavane, Suite 1210, 551 Fifth Avenue, New York, NY, 10176, US

(73) Assignee: Mannesmann VDO AG

(21) Appl. No.: 09/793,053

(22) Filed: Feb. 26, 2001

(30) Foreign Application Priority Data
Feb. 24, 2000 (DE) 100 08 496.6

(51) Int. Cl. F16D 3/52; F16D 3/56; F16D 3/64; F16D 3/72; F16D 3/76; F16D 3/78

(52) U.S. Cl. 464/99

(57) ABSTRACT

An elastic coupling for connecting a control element to a component which is to be adjusted by means of the control element, for example a flap-adjusting means of a heating system of a motor vehicle, has two discs which are axially spaced from each other. The disc has at least one radial slot in which the other disc engages with an axially oriented, elastic finger.

### BACKGROUND OF THE INVENTION

1. Field of the Invention

The invention relates to an elastic coupling for connecting a control element to a component which is to be adjusted by means of the control element, for example a flap-adjusting means of a heating system of a motor vehicle.

2. Description of the Related Art

Elastic couplings of the above type are generally known. They are required, for example, if the shaft of a rotary push button is mounted in a dashboard and the component which is to be adjusted by means of the rotary push button is arranged, for example, on a printed circuit board not fastened to the dashboard. Such separate fastening of the control element and of the component to be adjusted by it may cause alignment errors to occur which have to be compensated for by the elastic coupling. Since the distance of the control element from the component to be adjusted may also differ on account of tolerances, the elastic coupling additionally has to be capable of also enabling such changes in distance to be compensated for. Relatively imprecise tolerances occur in the case of dashboards having genuine wood surfaces. However, it is precisely in motor vehicles having dashboards of this type that it is desirable to avoid the negative impression of poorly aligned control elements.

In order to compensate for such alignment errors and differences in distance, it is known to connect the control element by means of a flexible shaft to the component to be adjusted by it. Universal connections having joints and provided with components which can be moved telescopically into one another are likewise known. However, the known tolerance-compensating means are disadvantageous in that they are of complicated design and often cause stiffness in the operation of the component to be adjusted.

### SUMMARY OF THE INVENTION

The invention provides an elastic coupling which is designed as simply as possible and can therefore be produced cost-effectively, but nevertheless is able to compensate for relatively imprecise tolerances without undesirable stiffness.

According to the invention, the coupling includes first and second discs which are axially spaced from each other. The first disc has at least one radial slot in which the second disc engages with an axially oriented, elastic finger.

This design compensates for the mismatch between the component and the control element in the one coordinate direction by displacing the elastic finger in the slot, and in the other coordinate direction by bending the finger. Changes in distance can be compensated for by the finger penetrating to a greater or lesser extent into the slot or by it protruding out of the slot to a greater or lesser extent on that side which faces away from the control element. Both the changes in distance and the mismatch in one coordinate direction are therefore compensated for by a sliding movement of the finger in the slot and therefore in a manner which is very low in friction. Since only the mismatch in the other coordinate direction has to be compensated for by bending the finger, the forces which are required for this and which become noticeable through an increase in the actuating forces, are very small.

It is advantageous if the finger has a rectangular cross section and its length runs in the direction of the slot. This results in the finger having sufficiently great strength while, at the same time, its bending is possible with relatively small forces.

A symmetrical application of force can be achieved in the coupling if the second disc has two fingers diametrically opposite in the vicinity of its periphery, and if the first disc correspondingly has one slot running over its center or two slots aligned with each other.

It is particularly favorable if, according to another development of the invention, the second disc has four fingers on a common pitch circle and the first disc correspondingly has four slots. With a coupling of this type particularly high forces can be transmitted without the actuating forces being increased to an undesirably high extent and without the forces being changed in an undesirable manner during the actuating movement.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a section through a control panel with a component arranged behind it;

shows a plan view of a first disc of an elastic coupling between the component and a control element of the component;

FIG. 3 shows a section through the first disc along the line III-III in FIG. 2;

FIG. 4 shows a plan view of a second disc of the coupling; and

FIG. 5 shows a side view of the second disc.

### DETAILED DESCRIPTION OF THE PRESENTLY PREFERRED EMBODIMENTS

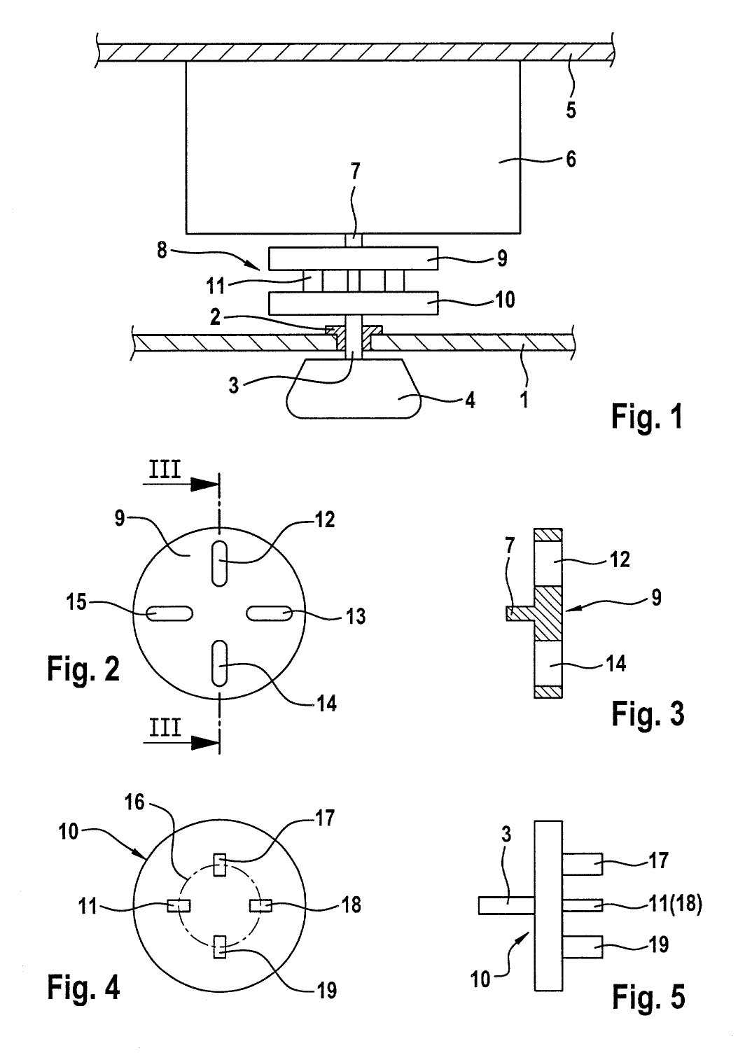

FIG. 1 shows a control panel 1 which may, for example, be a dashboard or a central console of a motor vehicle. A bearing body 2 is held in this control panel 1 and a shaft 3 of a control element 4, which is designed as a rotary push button, passes through it. Situated behind the control panel 1 is a printed circuit board 5 which is fastened to a part (not shown) of the motor vehicle. Fastened to this printed circuit board 5 is a component 6 which is designed as a potentiometer and into which a pin 7 forming the adjusting shaft of the potentiometer leads.

The pin 7 and the shaft 3 of the control element 4 are connected to each other by an elastic coupling 8. This coupling 8 has two circular discs 9, 10. The second disc 10 has elastic fingers 11 which engage in the first disc 9.

FIG. 2 shows that the disc 9 has four radially oriented slots 12, 13, 14, 15, while FIG. 3 shows that the disc 9 is formed integrally with the pin 7.

It can be seen from FIG. 4 that the disc 10 has a total of four fingers 11, 17, 18, 19 on a common pitch circle 16, the fingers each having a rectangular cross section and being dimensioned so that they can engage in the slots 12, 13, 14, 15.

FIG. 5 shows that the disc 10 has the shaft 3 on the side lying opposite the fingers 17, 18, 19, 11. The control element 4 which is shown in FIG. 1 is placed in a rotationally fixed manner on this shaft 3.

The invention is not limited by the embodiments described above which are presented as examples only but can be modified in various ways within the scope of protection defined by the appended patent claims.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. An elastic coupling for connecting a control element to a component which is to be adjusted by means of the control element, said coupling comprising;
a first disc having at least one radial slot, and
a second disc axially spaced from said first disk, said second disk having at least one axially extending finger which engages in said at least one radial slot.

2. An elastic coupling as in claim 1 wherein said at least one finger has a rectangular cross section with a length which is radially aligned in the radial slot.

3. An elastic coupling as in claim 1 wherein said second disc has two diametrically opposed fingers near its periphery, said first disc having at least one slot receiving said two fingers.

4. An elastic coupling as in claim 3 wherein said first disc has a pair of diametrically opposed slots on said common diameter.

5. An elastic coupling as in claim 1 wherein said second disc has four said axially extending fingers on a common pitch circle, said first disc having four slots which receive said four fingers.
